(19) United States
(12) Patent Application Publication
(10) Pub. No.: US 2018/0136174 A1
(43) Pub. Date: May 17, 2018

(54) PREPARATIVE CHROMATOGRAPH

(71) Applicant: Shimadzu Corporation, Kyoto (JP)

(72) Inventors: Takafumi Nakamura, Kyoto (JP); Tadayuki Yamaguchi, Tokyo (JP); Yusuke Nagai, Kyoto (JP)

(21) Appl. No.: 15/574,661

(22) PCT Filed: Jun. 1, 2015
(86) PCT No.: PCT/JP2015/065796

§ 371 Date: Nov. 16, 2017

(51) Int. Cl. G01N 30/38; G01N 30/74; G01N 30/82; G01N 30/84

(52) U.S. Cl. CPC G01N 30/38; G01N 30/74; G01N 2030/382; G01N 30/84; G01N 30/82

(57) ABSTRACT

A preparative chromatograph for collecting target components in a sample temporally separated in a column of a chromatograph in respective preparative containers is provided with: a detection unit having a flow cell accommodated in a housing and a detector for detecting a component that passes through the flow cell; a first pipe that connects the column and an inlet end of the flow cell; a flow path switching unit accommodated in the housing and configured to selectively flow the components that passed through the flow cell through a preparative flow path that is a flow path connected to the preparative containers or a waste liquid flow path; and a second pipe accommodated in the housing and connecting an outlet end of the flow cell and the flow path switching unit.

### TECHNICAL FIELD

The present invention relates to a preparative chromatograph for collecting target components separated in a column of a liquid chromatograph by a fraction collector.

### BACKGROUND ART

A preparative chromatograph is composed of a liquid chromatograph unit, a detector and a fraction collector arranged at a subsequent stage of the liquid chromatograph, and a control unit for controlling operations of the aforementioned devices. In the preparative chromatograph, components in a sample temporally separated and eluted in a column of the liquid chromatograph unit are detected when the components pass through the detector and introduced into a fraction collector to be collected in preparative containers (see, for example, Patent Document Nos. 1 and 2).

The liquid chromatograph unit is composed of, for example, a liquid supply pump, a sample injection unit, a column, etc. The components eluted from the column are introduced into a flow cell of a detector such as an absorption spectrophotometer through a pipe. In the detector, in addition to the flow cell, a light source such as a deuterium lamp, a diffraction grating, and a motor for driving the diffraction grating are accommodated in a single housing, and the components that passed through the flow cell are introduced to a fraction collector through a pipe. In the fraction collector, a preparative flow path to which a preparative container such as a vial bottle is connected, a waste liquid flow path to which a waste liquid container is connected, a flow path switching unit for selectively flowing components that passed through the detector to the preparative flow path or the waste liquid path are accommodated in a single housing.

In the preparative chromatograph, when a target component that passes through the flow cell is detected in the detector, the flow path switching unit is switched at the timing considering a time (delay time) required for the target component to reach the flow path switching unit of the fraction collector from the flow cell, so that the target component is collected in the preparative container. Specifically, when the delay time has elapsed from the detection start point of time of the target component, the flow path switching unit switches the flow path to the preparative flow path side, so that collection of the target component is initiated. When the delay time has elapsed from the detection end point of time of the target component, the flow path switching unit switches the flow path to the waste liquid flow path side, so that collection of the target component is completed. This delay time is calculated, for example, by dividing the capacity of the pipe from the flow cell of the detector to the flow path switching unit of the fraction collector by the flow rate (liquid feed amount per unit time) of a mobile phase (see, for example, Patent Document 3).

### PRIOR ART

### Patent Document

Patent Document 1: Japanese Unexamined Patent Application Publication No. 2000-214151
Patent Document 2: Japanese Unexamined Patent Application Publication No. 2007-183173
Patent Document 3: Japanese Patent No. 3268820

### Non-Patent Document

Non-Patent Document 1: MATSUSHITA, Itaru “Liquid Chromatograph Q&A 100” Gihodo, June 2000, ISBN 4-7655-0387-9, pp. 229

### SUMMARY

In a conventional preparative chromatograph, on the premise that a target component detected by a detector reaches a flow path switching unit when a delay time has elapsed, the flow path switching unit is switched to collect the target component. However, a diameter, a cross-sectional area, etc., of a pipe have manufacturing errors within a range of tolerance. Since the delay time is calculated based on a pipe capacity determined by the product of the diameter (cross-sectional area) of the pipe and the length of the pipe, the longer the pipe is, the larger the influence of the error of the pipe diameter becomes, so that the delay time becomes inaccurate.

The target component that passed through the flow cell flows through a pipe while diffusing in the mobile phase and reaches the flow path switching unit. Therefore, when the target component has reached the flow path switching unit, the peak start point of time of the target component is delayed, and the peak width is broad. As a result, there was a problem that the preparation was started even though the target component has not yet reached sufficiently or the preparation was terminated even though the peak of the target component was still continuing. Such a problem could not be covered by a simple delay time calculated by dividing the pipe capacity by the flow rate.

The exemplary preparative chromatographs disclosed herein may improve the collection of a target component.

Exemplary preparative chromatographs for collecting target components in a sample temporally separated in a column of a chromatograph in respective preparative containers, may include:

a) a detection unit having a flow cell accommodated in a housing and a detector for detecting components that pass through the flow cell;

b) a first pipe that connects the column and an inlet end of the flow cell;

c) a flow path switching unit accommodated in the housing and configured to selectively flow the components that passed through the flow cell to a preparative flow path which is a flow path to be connected to the respective preparative containers or a waste liquid flow path; and

d) a second pipe accommodated in the housing, the second pipe connecting an outlet end of the flow cell and the flow path switching unit.

In a conventional preparative chromatograph, a fraction collector (a flow path switching unit and preparative containers) and a detection unit are accommodated in separate housings, and a pipe connecting the flow cell and the flow path switching unit is arranged so as to connect both the housings. For this reason, depending on the arrangement of these housings, the length of the pipe connecting them became long, which increased the error of the delay time and the diffusion of the components in the pipe. In contrast, in the preparative chromatograph according to the present invention, since the detection unit (flow cell) and the flow path switching unit are accommodated in the same housing, it is normally possible to shorten the length of the second pipe as compared with the conventional one. This makes it possible to reduce the error of the pipe capacity as compared with a conventional preparative chromatograph, which in turn can make the delay time more accurate than the conventional one. Further, the diffusion of the target components can be kept small by shortening the second pipe, so that the target components can be assuredly collected more than before.

For the detection unit, an absorptiometer having LEDs as light sources can be suitably used. In a conventional preparative chromatograph absorption spectrophotometer, a white light source such as a deuterium lamp is used. For this reason, it is necessary to use a spectroscopic unit including a diffraction grating for extracting light of a desired wavelength and a motor for driving the diffraction grating, and therefore it was difficult to accommodate the entire absorption spectrophotometer within the housing of the fraction collector. On the other hand, when an LED light source with a narrow range of an emission wavelength is used, the spectroscopic unit (a diffraction grating and a motor) becomes unnecessary. Therefore, the entire detector can be accommodated in the housing with a reduced size.

In the case of using a detector having a light source such as a deuterium lamp and a spectroscopic unit like in the conventional case, only the flow cell may be accommodated in the housing and the irradiation light from the light source or the measurement light that passed through the flow cell may be transported using an optical fiber.

In a preparative chromatograph, normally, a rack in which a plurality of preparative containers is accommodated is arranged in the housing. Further, a fractionation head provided with an outlet end of a preparative flow path and a drive mechanism for moving the fractionation head in a horizontal direction and in a vertical direction and positioning the outlet end of the preparative flow path above a predetermined preparative container are provided.

Therefore, the preparative chromatograph according to some examples may further include:

e) a fractionation head attached to an outlet end of the preparative flow path, wherein the flow cell, the second pipe, and the flow path switching unit are mounted on the fractionation head; and

f) a drive mechanism configured to move the outlet end of the preparative flow path among the preparative containers.

In the preparative chromatograph of the aforementioned embodiment, the flow cell and the flow path switching unit are mounted on the fractionation head. That is, since the flow cell and the flow path switching unit move together with the fractionation head, it is not necessary to consider the movement of the fractionation head, so that the second pipe can be further shortened. Further, by arranging the flow cell and the flow path switching unit adjacently, it is possible to fractionate the target components without the delay time.

Preparative chromatographs disclosed herein may be implemented with shortened pipe length from the flow cell to the flow path switching unit, which may suppress the delay time error and diffusion of target components. This in turn enables better collection of target components.

### BRIEF DESCRIPTION OF THE DRAWINGS

FIG. 1 is a configuration diagram of a main part of one example of a preparative chromatograph according to an embodiment of the present invention.

FIG. 2 is an explanatory diagram relating to a fractionation head of the preparative chromatograph of this example.

FIG. 3 is a configuration diagram of a main part of an absorptiometer of the preparative chromatograph of this example.

FIG. 4 is a comparison of pipes, etc., between the preparative chromatograph of this example and a conventional preparative chromatograph.

### DETAILED DESCRIPTION

Examples of a preparative chromatograph according to exemplary embodiments of the present invention will be described below with reference to drawings.

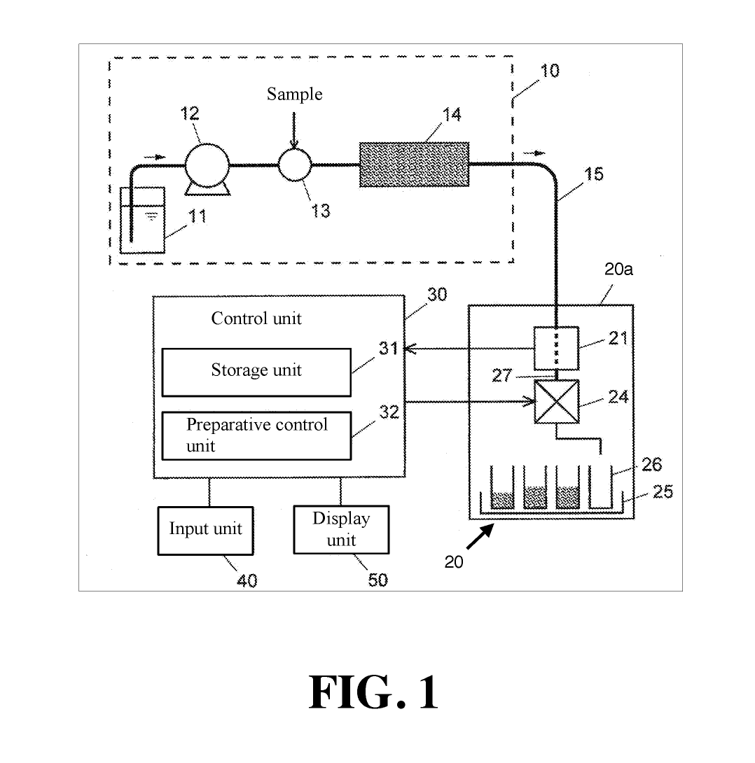

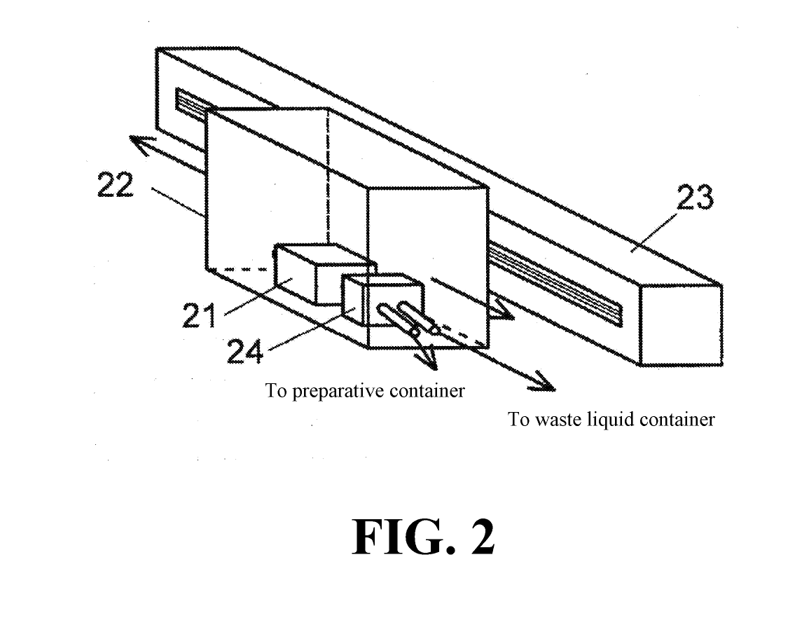

FIG. 1 shows a configuration of a main portion of a preparative chromatograph of this example. FIG. 2 shows a configuration of a main portion of a fraction collector 20 of the preparative chromatograph. The preparative liquid chromatograph of this example is roughly composed of a liquid chromatograph unit 10 for separating target components contained in a sample, a fraction collector 20 for collecting the target components separated by the liquid chromatograph unit 10, and a control unit 30 for controlling operations of these devices.

In the liquid chromatograph unit 10, a mobile phase in a mobile phase container 11 is sucked up by a liquid supply pump 12 and fed to a column 14 at a predetermined flow rate. A sample containing the target component is injected at a sample injection unit 13 and transported to the column 14 by the flow of the mobile phase. The target components in the sample are temporally separated and eluted within the column 14. The units of the liquid chromatograph unit 10 are accommodated in respective housings and connected by a pipe, respectively.

The fraction collector 20 is provided with an absorptiometer 21 equipped with three LEDs 211a, 211b, and 211c which are different in light emission wavelength as light sources, a fractionation head 22, a moving mechanism (a rail 23, motor, etc.) of the fractionation head 22, and an electromagnetic valve 24. The absorptiometer 21 and the electromagnetic valve 24 are connected by a second pipe 27 and are accommodated inside of the fractionation head 22 and configured to be moved along the rail 23 together with the fractionation head 22. In the fraction collector 20, a plurality of preparative containers 26 accommodated in a rack 25 are placed. The parts of the fraction collector 20 are accommodated in a single housing 20a.

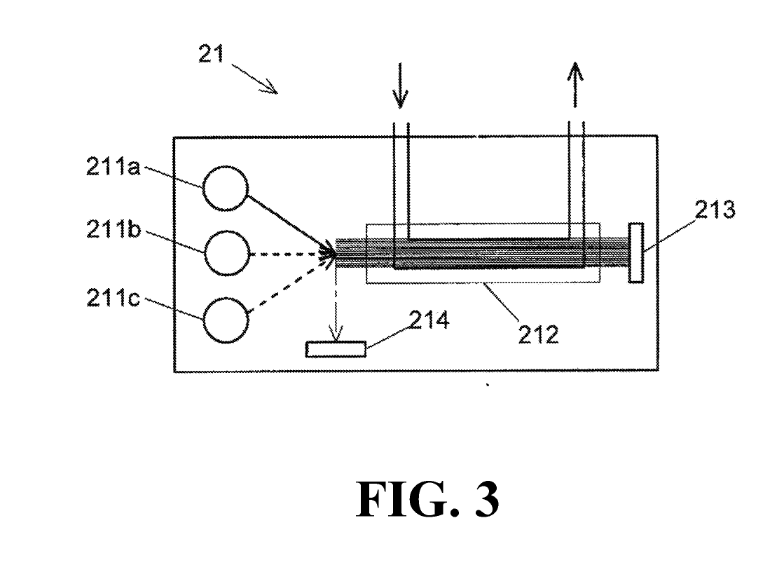

The components separated in the column 14 of the liquid chromatograph unit 10 are introduced into the flow cell 212 of the absorptiometer 21 through the first pipe 15. The configuration of the main part of the absorptiometer 21 is shown in FIG. 3. In the absorptiometer 21, three LEDs 211a, 211b, and 211c are light sources that emit light of wavelength bands to be absorbed by three kinds of target components to be prepared, and the light is irradiated in a time division manner (that is, the light emitted from the three LEDs is sequentially irradiated) to the flow cell 212 in accordance with the control signal from a preparative control unit 32. Then, the measurement light that passed through the flow cell 212 is detected by a first photodiode 213. A part of the light emitted from each of the LEDs 211a, 211b, and 211c is detected by a second photodiode 214. The detection signals from the first photodiode 213 and the second photodiode 214 are sent to the control unit 30. In the control unit 30, after calculating the absorbance of light of three kinds of wavelengths, a chromatogram is created and displayed on a screen of the display unit 50, which will be described later.

When the target component is detected in the absorptiometer 21, the electromagnetic valve 24 is switched by a preparative control unit 32 which will be described later, and the target component that passed through the flow cell 212 is collected into a preparative container through a preparative flow path. After the target component has passed, the electromagnetic valve 24 is switched again by the preparative control unit 32, so that the component that passed through the flow cell 212 is guided to a waste liquid flow path.

The control unit 30 is equipped with a storage unit 31 and a preparative control unit 32. The preparative control unit 32 is a functional block for controlling the operation of each part of the liquid chromatograph unit 10 and the fraction collector 20. Also, the input unit 40 and the display unit 50 are connected to the control unit 30.

The preparative control unit 32 makes the display unit 50 display a preparative condition input screen on the display unit 50 so that a user can input a pipe capacity of the second pipe 27 and a liquid supply flow rate of the liquid supply pump 12. When these are input, the delay time is calculated from the pipe capacity and the liquid transfer flow rate and stored in the storage unit 31. The delay time is a time required for the (target) component detected in the absorptiometer 21 to reach the electromagnetic valve 24. The preparative control unit 32 switches the flow path of the electromagnetic valve 24 to the preparative flow path side at the time when the delay time has elapsed from the detection starting point of time of the target component in the absorptiometer 21 to start collection of the target component, and switches the flow path of the electromagnetic valve 24 to the waste liquid flow path side when the delay time has elapsed from the detection end point of time of the target component to finish collection of the target component.

As described above, the absorptiometer 21 in this example uses the LEDs 211a, 211b, and 211c that each emits light having a wavelength to be absorbed by a target component as light sources. Therefore, it is unnecessary to provide a spectroscope like a conventional absorptiometer using a white light source such as a mercury lamp. Therefore, the absorptiometer 21 is compact and can be accommodated in the fractionation head 22. In addition, in this example, since the internal electromagnetic valve 24 of the fractionation head 22 is also accommodated, the pipe length of the second pipe 27 that connects the flow cell 212 of the absorptiometer 21 and the electromagnetic valve 24 is shorter than the conventional one. Therefore, it is possible to reliably collect a target component by reducing the error of the delay time caused by variation in diameter of the pipe occurring at the time of manufacturing. Furthermore, it is possible to directly connect the flow cell 212 of the absorptiometer 21 and the electromagnetic valve 24 (in this case, the second pipe according to the present invention is a boundary thereof), which enables collection of a target component without delay time. Although FIG. 2 shows an example in which the absorptiometer 21 and the electromagnetic valve 24 are accommodated in the fractionation head 22, the absorptiometer 21 and the electromagnetic valve 24 can be mounted on the upper surface or the side surface of the preparative head 22.

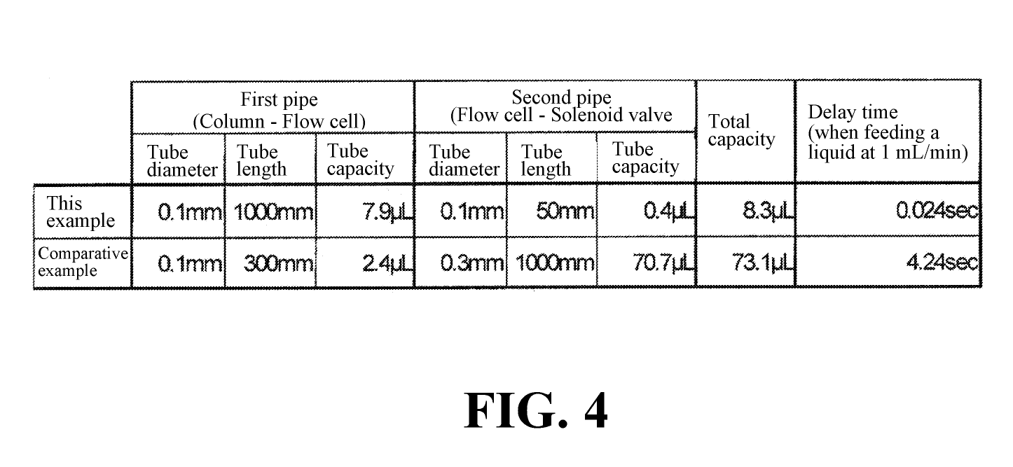

Regarding each of the configuration of the aforementioned example and a conventionally used configuration (comparative example), hereinafter, the results of calculating the delay time which depends on the pipe capacity from the detector to the electromagnetic valve and the diffusion capacity which depends on the pipe capacity from the column to the electromagnetic valve will be explained. FIG. 4 compares the configuration of this example and that of the comparative example. In both the example and the comparative example, the flow rate was set to 1,000 μL/min.

As shown in FIG. 4, the diameter of the first pipe 15 (the column 14 to the flow cell 212) of the preparative chromatograph of this example was ϕ 0.1 mm, the length thereof was 1,000 mm, and the capacity thereof was 7.9 μL. The diameter of the second pipe 27 (the flow cell 212 to the electromagnetic valve 24) was ϕ 0.1 mm, the length thereof was 50 mm, and the capacity thereof was 0.4 μL. On the other hand, in a conventional preparative chromatograph, the diameter of the first pipe (the column to the flow cell) was ϕ 0.1 mm, the length thereof was 300 mm, and the capacity thereof was 2.4 μL. The diameter of the second pipe (the flow cell to the electromagnetic valve) was ϕ 0.3 mm, the length thereof was 1,000 mm, and the capacity thereof was 70.7 μL. The diameter of the second pipe is different from the others (thicker than the other) because the pressure resistance of the detector flow cell is low. In other words, if a narrow and long pipe is connected to the outlet end of the flow cell of the detector, the backpressure becomes too high, which causes leakage. On the other hand, in the preparative chromatograph of this example, since the second pipe 27 is short, even if the pipe diameter is small, there is no worry that an excessive back pressure will be applied to the flow cell.

Under the above conditions, a delay time was obtained by dividing the capacity of the second pipe by the flow rate. As a result, the delay time was 4.24 sec in the comparative example, whereas the delay time was 0.024 sec in this example. That is, it can be understood that the target component can be assuredly collected without substantial delay time.

For each of the example and comparative example, the diffusion capacity from the column to the electromagnetic valve was determined by the following equation described in Non-Patent Document 1.

$$\begin{matrix}[ Formula 1 ] & \\ {σ}_{v}^{2} = \frac{π {d}^{4} {LF}_{v}}{385 {D}_{m}} & ( 1 )\end{matrix}$$

In the above formula (1), σᵥ is a diffusion capacity (μL), d is a pipe diameter (mm), L is a pipe length (mm), Fᵥ is a flow rate (μL/sec), and Dₘ is a diffusion coefficient (0.002 mm²/sec, a general value).

As a specific example, a case is considered in which a target component that passed through a column with a spread corresponding to a peak of 1.0 sec (full width at half maximum). From the above flow rate Fᵥ=1,000 μL/min, when the full width at half maximum of the peak of the target component is represented by a flow rate, it becomes 16.67 μL. Since a spread of a target component is usually expressed by a Gaussian distribution and, in the Gaussian distribution, the full width at half maximum=2.35 σᵥ, the diffusion capacity of the target component is σᵥ=7.09 μL.

Next, for each of the example and the comparative example, σᵥ is calculated from the aforementioned equation (1) using the pipe diameter and the pipe length shown in FIG. 4, the flow rate Fᵥ=1,000 μL/min, and the diffusion coefficient Dₘ=0.002 mm²/sec. Then, it becomes σᵥ=2.61 μL in the first pipe of this example, and it becomes σᵥ=0.58 μL in the second pipe thereof. In the first pipe of the comparative example, it becomes σᵥ=1.43 μL, and in the second pipe thereof, it becomes σᵥ=23.46 μL. Finally, when the total σᵥ is calculated from the three squared values σᵥ (σᵥ at the time of exiting the column, σᵥ of the first pipe, and σᵥ of the second pipe) by the root mean square, it becomes σᵥ=7.58 μL in this example, and it becomes σᵥ=24.55 μL in the comparative example. When these values are converted to seconds in accordance with the flow rate Fᵥ, it becomes σᵥ=0.45 sec in this example, and it becomes σᵥ=1.47 sec in the comparative example. Finally, when these are converted to a full width at half maximum, it becomes 1.07 sec in this example and 3.46 sec in the comparative example. That is, in the comparative example, the target component diffuses to the peak of 3.46 sec (full width at half maximum), whereas in this example it is suppressed to the peak of 1.07 sec (full width at half maximum). Therefore, in the preparative chromatograph of this example, the target component can be reliably collected without diffusing the target component in the mobile phase.

The aforementioned example is merely one example and can be appropriately changed in accordance with the spirit of the present invention. For example, in the aforementioned example, the light from the three types of LEDs 211a, 211b, and 211c is irradiated on the flow cell 212 in a time division manner in the absorptiometer 21. However, in cases where the elution order of the target components that absorb light of each wavelength is known beforehand, the LEDs may be used by switching in that order. Further, the number of LEDs to be used may be appropriately changed. Also, a mercury lamp which is narrow in spectrum like an LED may be used instead of the LED.

In the aforementioned example, the absorptiometer 21 is used as a detector, but other detectors (a fluorescence detector, an electric conductivity detector, a differential refractive index detector, etc.) can also be used. Also, a plurality of detectors can be used in combination.

Further, in the same manner as in a conventional detector, an absorption spectrophotometer which uses white light source can also be used. In that case, only the flow cell is placed in the fractionation head of the fraction collector, and a spectroscopic unit (e.g., diffraction grating) for extracting monochromatic light from white light emitted from the light source is placed at an arbitrary position inside or outside the housing of the fraction collector. Then, monochromatic light taken out in the spectroscopic unit can be transported by an optical fiber and irradiated to the flow cell.

In addition, in the aforementioned example, the absorptiometer 21 is placed inside of the fractionation head 22, but it may be placed at another position within the housing of the fraction collector.

### DESCRIPTION OF REFERENCE SYMBOLS

10: liquid chromatograph unit
11: mobile phase container
12: liquid supply pump
13: sample injection unit
14: column
15: first pipe
20: fraction collector
20a: housing
21: flow cell
21: absorptiometer
211a to 211c: LED
212: flow cell
213: first photodiode
214: second photodiode
22: fractionation head
23: rail
24: electromagnetic valve
25: rack
26: preparative container
27: second pipe
30: control unit
31: storage unit
32: preparative control unit
40: input unit
50: display unit

1. A preparative chromatograph for collecting target components in a sample temporally separated in a column of a chromatograph in respective preparative containers, comprising:
a) a detection unit having a flow cell accommodated in a housing and a detector for detecting components that pass through the flow cell;
b) a first pipe that connects the column and an inlet end of the flow cell;
c) a flow path switching unit accommodated in the housing and configured to selectively flow the components that passed through the flow cell to a preparative flow path which is a flow path to be connected to the respective preparative containers or a waste liquid flow path; and
d) a second pipe accommodated in the housing, the second pipe connecting an outlet end of the flow cell and the flow path switching unit.

2. The preparative chromatograph as recited in claim 1,
wherein the detection unit is an absorptiometer equipped with an LED light source.

3. The preparative chromatograph as recited in claim 1,
wherein the detection unit is equipped with an optical fiber that transmits irradiation light emitted from a light source arranged outside the housing and irradiated to the flow cell.

4. The preparative chromatograph as recited in claim 1, further comprising:
e) a fractionation head attached to an outlet end of the preparative flow path, wherein the flow cell, the second pipe, and the flow path switching unit are mounted on the fractionation head; and
f) a drive mechanism configured to move the outlet end of the preparative flow path among the preparative containers.

5. The preparative chromatograph as recited in claim 2, further comprising:
e) a fractionation head attached to an outlet end of the preparative flow path, wherein the flow cell, the second pipe, and the flow path switching unit are mounted on the fractionation head; and
f) a drive mechanism configured to move the outlet end of the preparative flow path among the preparative containers.

6. The preparative chromatograph as recited in claim 3, further comprising:
e) a fractionation head attached to an outlet end of the preparative flow path, wherein the flow cell, the second pipe, and the flow path switching unit are mounted on the fractionation head; and
f) a drive mechanism configured to move the outlet end of the preparative flow path among the preparative containers.
